(19) United States
(12) Patent Application Publication
(10) Pub. No.: US 2014/0065371 A1
(43) Pub. Date: Mar. 6, 2014

(54) SPACING DEVICE FOR STACKING IDENTICALLY SHAPED PLASTIC MOLDED PARTS

(71) Applicant: CARCOUSTICS TECHCONSULT GMBH, Leverkusen (DE)

(72) Inventors: Johannes KOPF, Sulz (AT); Richard GEIBLER, Horbranz (AT); Markus LUGER, Hohenems (AT)

(73) Assignee: CARCOUSTICS TECHCONSULT GMBH, Leverkusen (DE)

(21) Appl. No.: 13/916,714

(22) Filed: Jun. 13, 2013

(30) Foreign Application Priority Data
Jun. 13, 2012 (DE) 20 2012 102 178.1

(51) Int. Cl. B60J 10/00

(52) U.S. Cl. CPC B60J 10/0048
USPC 428/157; 428/174

(57) ABSTRACT

A spacing device for stacking at least two identically formed, flat plastic molded parts having a contour formed by at least one raised portion, which forms a corresponding depression on the other side of a respective plastic molded part, with at least one peripheral adhesive bead, with which the plastic molded parts, upon being attached to a vehicle component, can each be sealed against the latter, being applied on the edge of each plastic molded part, where the spacing device includes at least two spacer elements and is configured and positionable between two plastic molded parts in such a way that the spacer elements are in contact with both plastic molded parts such that the two plastic molded parts do not touch each other during stacking, and the adhesive bead of a lower plastic molded part does not touch the plastic molded part stacked above it.

### TECHNICAL FIELD

The invention relates to a spacing device.

### BACKGROUND

Usually, various components, such as window lifters, door opening and door closing mechanisms, loudspeakers, airbags, etc. are accommodated between the outer door panel and the interior trim of a vehicle door. For this purpose, a window-like assembly opening is frequently provided in the inner door panel, into which these components can be inserted on a pre-mounted unit support member. This unit support member can be a self-supporting plastic molded part, which is fitted with the different components. For this purpose, raised portions or depressions are provided in the plastic molded part in order to mount the components at the intended positions, and the unit support member is installed in such a way that it covers the assembly opening in the inner door panel and seals it in a moisture-tight manner.

After the installation of the unit support member, the plastic molded part must therefore be sealed against the inner door panel so that no moisture is able to enter the interior trim. In order to establish such a seal, it is known to attach a peripheral butyl seal on the edge on the installation side of the plastic molded part used. This is preferably done using a robot that applies the heated butyl seal on the edge in the form of a sealing bead. The material can well be applied from a nozzle, with small radii in the corners of the plastic molded part also being capable of being realized. A hot melt adhesive such as hot-melt, which is heated and applied in the desired sealing region of the plastic molded part by means of a nozzle, can be used as an adhesive material.

This also applies to other plastic molded parts that are sealed on to a vehicle component with a peripheral adhesive bead. For example, this is also the case for sound insulation installed on a vehicle door.

After the sealing bead has been applied to a plastic molded part, its surface is adhesive, so that it has to be covered with a protective sheet for transporting and storing the plastic molded part. In this case, either only the sealing bead is covered with a narrow covering strip, or the entire plastic molded part is covered with a protective sheet which then adheres to the sealing bead. Prior to the installation of the plastic molded part to a vehicle component the respective protective sheet is removed, and during installation the sealing bead is pressed against the vehicle component and adheres to it. A liquid-tight connection between the plastic molded part and, for example, an inner door panel is thus produced.

Because the respective sealing material is heated in order to be applied, however, a certain cooling-off time is required before the plastic molded part can be transported and stored. To this end, several plastic molded parts are usually stacked one above the other, whereby the seals can be deformed and damaged if they are still too soft. The required cooling-off time prior to stacking can thus have a disadvantageous effect on the cycle time in the manufacture of the plastic molded parts. Furthermore, the sealing bead may be damaged during transport and storage of the plastic molded parts despite prior cooling, which has a negative effect on the sealing properties.

Furthermore, the application of a strip-shaped protective sheet on the adhesive surface of a sealing bead requires some effort, whereas the application of a larger protective sheet on the entire plastic molded part is easier but requires a lot of protective sheet material, which then has to be disposed of. In turn, this is disadvantageous with respect to environmental and cost aspects.

### BRIEF SUMMARY

The invention provides alternative means that prevent damage to sealing beads on the plastic molded part when stacking such identically shaped plastic molded parts.

Consequently, the spacing device according to the invention is suitable for stacking at least two identically formed, flat plastic molded parts having a contour formed by at least one raised portion, which forms a corresponding depression on the other side of a respective plastic molded part. In this case, at least one peripheral adhesive bead (sealing bead), with which the plastic molded parts, upon being attached to a vehicle component, can each be sealed against the latter, is applied on the edge of each plastic molded part. In order to protect this adhesive bead when stacking two plastic molded parts, the invention provides that the spacing device comprises at least two spacer elements and is configured and positionable between two plastic molded parts in such a way that the spacer elements are in contact with both plastic molded parts. The height, shape and/or arrangement of the at least two spacer elements are in that case selected in such a way that the two plastic molded parts do not touch each other during stacking and that the adhesive bead of a lower plastic molded part does not touch the plastic molded part stacked above it. In this case, at least one first spacer element is located in an outer region of the plastic molded parts close to the adhesive bead, whereas at least one second spacer element is located in a central region of the plastic molded parts. By the two plastic molded parts being held at a predetermined distance from each other by the spacer elements, the spacing device thus enables at least two plastic molded parts to be stacked without the adhesive bead applied thereto being damaged. Thus, complicated and elaborate adhesive bead coverings composed of coated sheet or paper can be omitted, which in turn leads to a reduction of waste and a saving of costs.

In particular, at least one first spacer element close to the adhesive bead serves for ensuring the required distance between two plastic molded parts in this sensitive region. In contrast, at least one other second spacer element in the central region of the plastic molded parts serves for preventing an upper plastic molded part from sagging. Since the adhesive beads are applied on the outer edge of the plastic molded parts, spacer elements exclusively in this edge region could otherwise lead to sagging in the central region.

In this case, a second spacer element, which can also be referred to as a supporting member, does not have to lie exactly in the middle of the plastic molded part during stacking; for this invention, this rather only refers to a central region in contrast to an outer edge region. In this case, several second spacer elements can also be provided which are suitably distributed in this central region. Preferably, the distance between the two plastic molded parts produced by the spacing device is then approximately constant over the contour of the plastic molded parts, with the distance not having to be to be exactly constant but slight deviations in the millimeter range also being comprised by the invention.

The first and second spacer elements can assume any shape, with elements such as domes, webs, pins, ribs, profiles or combinations thereof having proved advantageous. The arrangement of the spacer elements can also be suitably selected and, in particular, adapted to the contour of the plastic molded parts. For example, the at least one first spacer element can lie inside or outside the region of a lower plastic molded part formed by the peripheral adhesive bead, when the at least two plastic molded parts are being stacked. In the case of the first spacer elements located outside, they can also protect the adhesive bead against damage from the side, depending on the configuration of the spacer elements. However, since the distance between the outer edge of the plastic molded parts and the adhesive bead is frequently only very small, it may be advantageous to arrange the spacer elements within the adhesive bead close to the latter.

The distance between the adhesive bead and the first spacer elements can be, for example, in the order of magnitude from 0.2 mm to 2 cm. It should be large enough to be able to position the spacer elements safely in the region of the adhesive bead when stacking several plastic molded parts, without the spacer elements touching the adhesive bead. However, it should also not be too large, because otherwise, the spacer elements cannot produce a sufficient distancing or supporting effect in the sensitive region of the adhesive beads.

In one embodiment of the invention, at least one spacer element is configured and arranged in such a way that it also aligns the two plastic molded parts relative to one another during stacking. Since the plastic molded parts are shaped identically and typically with an approximately constant material thickness, they have a contour in which a raised portion on one side of a plastic molded part in each case forms a depression on the other side of the plastic molded part. Thus, the plastic molded parts can be stacked well and stored in a space-saving manner, because a raised portion always inserts itself into an associated depression of the next plastic molded part during stacking. This immediate positive fit is prevented by the spacing device, so that means, and in particular spacer elements, are preferably provided on the spacing device which nevertheless cause or at least facilitate an alignment of the plastic molded parts to form a straight stack. In that case, the spacing devices prevent the plastic molded part from slipping within the stack.

In this case, the spacing device according to the invention can be realized in different ways. In a first embodiment of the invention, for example, the spacing device comprising the at least two spacer elements is at least temporarily a firmly attached component of each plastic molded part. Thus, corresponding spacer elements are attached to or integrally molded on each plastic molded part, so that two plastic molded parts are kept at a distance by these spacer elements during stacking. These spacer elements can be firmly connected to a plastic molded part, which, in the sense of the invention, means that they are in contact with the respective plastic molded part. However, they can also be configured to be detachable, which, until the spacer elements are removed, is also to be considered a contact with the respective plastic molded part.

In contrast, in a second embodiment of the invention, the spacing device with the at least two spacer elements is a separate component which can be inserted as an intermediate layer between two plastic molded parts to be stacked. In this case, the spacing device constitutes a reusable component which is placed between two plastic molded parts during stacking and subsequently removed again in order to then use it for a new stack. With respect to environmental aspects, reusability is very advantageous and, over the lifespan, also leads to a saving of costs compared with solutions comprising single-use coverings composed of sheets or paper.

Possible materials for the intermediate layer include thin-film and thick-film sheets based on polyolefins and closed-cell foam sheets and panels. In this case, foam blocks, and in particular rigid foams composed of polyethylene or polyethylene terephthalate can be used. Furthermore, they can be slightly open-pore materials, such as, for example, higher-density foams or pre-compacted EPP and PEPP panels (expanded polypropylene and porous expanded polypropylene). In particular, closed-cell foam sheets composed of polyethylene (PE foam sheets) can be used. Deep-drawing is an appropriate manufacturing process, and the design of the intermediate layer as a distancing and supporting member can in this case be produced in a “one shot” process.

Like the plastic molded parts, the intermediate layer can have an approximately constant material thickness and a contour in which a raised portion on one side of the intermediate layer forms a corresponding depression on the other side of the intermediate layer. In this case, the intermediate layer preferably has a contour that corresponds to, or at least approximately follows, the contour of the plastic molded part to be stacked, with the at least two spacer elements protruding from this contour. The distance between the two plastic molded parts created by introducing the spacing device then corresponds at least to the sum of the material thickness of the intermediate layer and the height of the spacer elements protruding from the contour. For example, the material thickness of the intermediate layer can be in the order of magnitude of 2-10 mm and, in particular, 5 mm, whereas the desired distance to be achieved is in the order of magnitude of 10 mm-30 mm, so that the height of the spacer elements has to be selected accordingly.

This is advantageous in that as thin and light an intermediate layer as possible can be selected, which can easily be interposed between two plastic molded parts. Since that would usually not suffice to produce a sufficiently large distance between two plastic molded parts, the spacer elements additionally protrude from the contour of this intermediate layer and thus cause the required distance and, if necessary, also an alignment of plastic molded parts relative to one another. However, since the contour of the intermediate layer, with the exception of the spacer elements, follows the contour of the plastic molded parts to be stacked, this facilitates the stacking and alignment process, and the plastic molded parts can still be stacked in as space-saving a manner as possible.

In one variant of the invention, the circumference of the intermediate layer is smaller than the circumference of the plastic molded parts, so that an intermediate layer, if introduced centrally between two plastic molded parts, does not protrude outwards over an adhesive bead. The spacing device is in that case to be introduced in its entirety into a region delimited by the peripheral adhesive bead. At least one first spacer element located close to the adhesive bead in that case lifts the upper plastic molded part to such an extent that its underside does not come into contact with the adhesive bead located thereunder.

However, it may also be provided that the at least one first spacer element is located within the region of a plastic molded part formed by the peripheral adhesive bead in such a way that the intermediate layer protrudes outwards over an adhesive bead without, however, touching it. Thus, the adhesive bead can be additionally protected against pressure from above on the plastic molded part. In this case, the circumference of the intermediate layer can approximately correspond to the circumference of the plastic molded parts or be slightly smaller. It may even be larger, so that the intermediate layer protrudes outwards between the stacked plastic molded parts. The removal of the intermediate layers could thus be facilitated, because they can thus be better grasped at their edges.

In the case of a separate spacing device as an intermediate layer between two plastic molded parts, the spacer elements can also assume different shapes and positions. For example, several first spacer elements in the form of webs and/or pins can be formed on the outer edge of the intermediate layer. With regard to their shape, the webs can in this case, in particular, extend perpendicularly towards the outer edge of the intermediate layer.

In another exemplary embodiment, a first spacer element in the region of the adhesive bead is formed by the outer edge of the intermediate layer being configured as an L-shaped or U-shaped profile. In that case, the correspondingly configured outer edge itself serves as a spacer element, with the legs of the selected profile causing the required distance.

Moreover, at least one second spacer element in the form of a dome can be formed in a central region of the intermediate layer. This dome is well-suited in order to form, over a certain surface, a dome-like supporting member on which a plastic molded part can rest so as not to sag in that region.

Moreover, at least one spacer element is configured and disposed in such a way that, when the spacing device is introduced as an intermediate layer between two plastic molded parts to be stacked, at least one side surface of the spacer element rests against an inner surface of a depression within the contour of a plastic molded part, whereby the two plastic molded parts are aligned relative to one another. In the process, this spacer element engages the raised portion or depression of an adjacent plastic molded part in such a way that, thus, an alignment of the intermediate layer relative to this plastic molded part takes place simultaneously. If the intermediate layer is also aligned relative to a second plastic molded part in the same way, an alignment of two plastic molded parts relative to each other thus also takes place.

### BRIEF DESCRIPTION OF THE DRAWINGS

Other advantages, special features and expedient further developments of the invention are apparent from the dependent claims and the following presentation of preferred embodiments with reference to the illustrations.

In the Figures:

FIG. 1 shows a cross section through the lower region of a motor vehicle door with an installed plastic molded part;

FIG. 2a shows a cross section through an exemplary embodiment of a plastic molded part to be stacked;

FIG. 2b shows a top view of an exemplary embodiment of a plastic molded part to be stacked;

FIG. 3 shows a cross section through a first embodiment of the spacing device according to the invention as a firmly attached component of the plastic molded parts to be stacked;

FIG. 4 shows a cross section through a second embodiment of the spacing device according to the invention as a separate intermediate layer;

FIG. 5 shows a cross section through a separate intermediate layer with an L-shaped edge region;

FIG. 6 shows a cross section through a separate intermediate layer with a U-shaped edge region and an aligning spacer element;

FIG. 7a shows a schematic top view of a separate intermediate layer with a U-shaped edge region and several ribs;

FIG. 7b shows an enlarged section from a U-shaped edge region with a rib according to FIG. 7a; and

FIG. 8 shows a schematic top view of a plastic molded part with an intermediate layer placed thereon.

### DETAILED DESCRIPTION

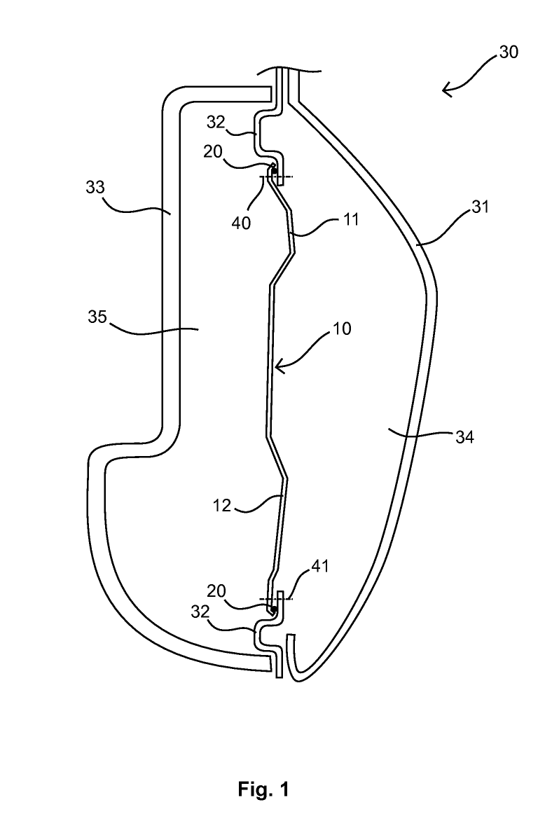

The attachment of a plastic molded part to a vehicle door by means of an adhesive seal is to be explained by way of example with reference to FIG. 1. This is a possible example of a plastic molded part in which several plastic molded parts are stacked prior to being affixed to a vehicle component. However, the invention can also be used for stacking other plastic molded parts that are attached to a vehicle component and sealed against the latter by means of a peripheral adhesive bead. In particular, this can pertain to sound insulation members on vehicle doors.

FIG. 1 shows the lower region of a motor vehicle door 30 in a cross section, with an outer door panel 31 and an inner door panel 32. A window-like assembly cut-out, in which a unit support member with pre-mounted components, such as window lifters, door opening and door closing mechanisms, loudspeakers, airbags, etc., is being accommodated, is formed in the inner door panel 32. For this purpose, a plastic molded part 10 on which the components can be pre-mounted is provided as a unit support member, wherein these components are not depicted in FIG. 1, only the support member in the form of a plastic molded part 10. For this purpose, the plastic molded part 10 usually comprises raised portions or depressions for accommodating the individual components, as is schematically shown in FIG. 1 in the form of depressions/raised portions 11 and 12.

The plastic molded part 10 is mounted on the inner door panel 32 by means of fastening members 40 and 41, with, however, more than the two fastening members depicted being possible. The fastening members can be configured in different ways, with tabs, pin and clip connections being known. In this case, the fastening members 40, 41 can be positioned within and/or outside a peripheral seal 20.

The seal 20 is configured in the form of a peripheral adhesive bead sealing the plastic molded part 10 against the inner door panel 32 after installation. Thus, a wet space 34 is created between the inner door panel 32 together with the plastic molded part 10 and the outer door panel 31. Moisture can enter this wet space 34 when it enters, for example, from above through the window well. Due to the sealing bead 20, however, the wet space 34 is sealed against the dry space 35 which is formed together with the plastic molded part 10 between the inner door panel 32 and the inner door trim 33. Thus, no moisture can enter the interior of the associated vehicle.

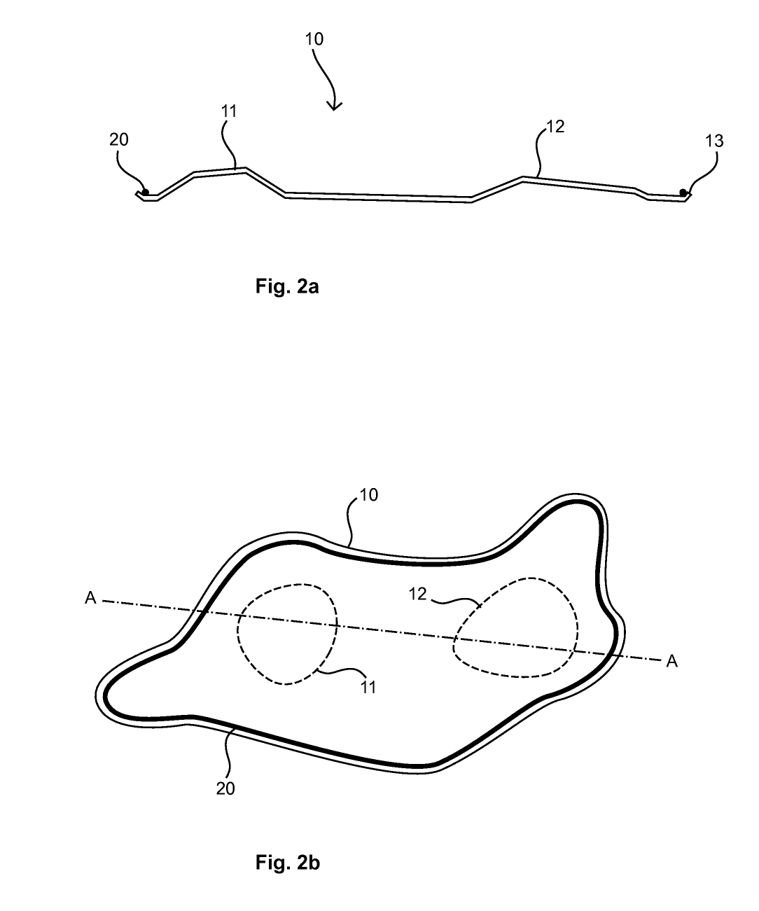

FIG. 2a shows a schematic cross section through an exemplary embodiment of such a plastic molded part 10 with a contour, which provides two raised portions or depressions 11 and 12 in the region of the section. The material thickness of the plastic molded part 10 is preferably approximately constant in all regions, wherein constant, within the sense of this invention, is supposed to mean that the contour of the plastic molded part 10 with at least one raised portion or depression comprises no specific portions of thickened material or thinned material, but is produced by appropriate shaping. However, portions of thickened material or thinned material may result due to the manufacture of the plastic molded part, for example, in corners and bent portions, or if individual areas are configured in a thickened manner for reasons of stability. However, each raised portion on one side of a plastic molded part 10 usually at the same time means a corresponding depression on the other side of the plastic molded part 10. If several of these plastic molded part are stacked one above the other, one raised portion, respectively, would thus insert itself into a corresponding depression of the adjacent plastic molded part.

A peripheral raised edge 13 is preferably formed in the edge region of the plastic molded part 10 in order to retain an also peripheral sealing bead 20 on the plastic molded part 10. If the plastic molded part 10, when it is being attached to a vehicle component, is pressed against the latter, the sealing material cannot escape towards the outside. The raised edge 13 also facilitates the application of the sealing bead 20. Additionally, it may be provided that the sealing bead 20 is inserted into a furrow, so that the sealing bead 20 is delimited on both sides by the furrow.

FIG. 2b shows, also only schematically, a top view of an exemplary embodiment of such a plastic molded part 10 on whose edge region a peripheral sealing bead 20 is applied. The outline of the plastic molded part 10 can in this case be shaped in any way, and the sealing bead 20 substantially follows this outline. These may, for example, be simple shapes such as rectangles or ovals; however, the outline may also be shaped in an irregular manner or comprise several bulges or indentations, as is the case in the exemplary embodiment of FIG. 2b. In this case, raised portions or depressions are formed at different locations within the surface area of the plastic molded part 10 and depicted in FIG. 2b in dashed lines. For example, a section A-A through the raised portions/depressions 11 and 12 would approximately lead to the illustration of FIG. 2a. These raised portions/depressions can also be shaped in any way and also have different depths or heights.

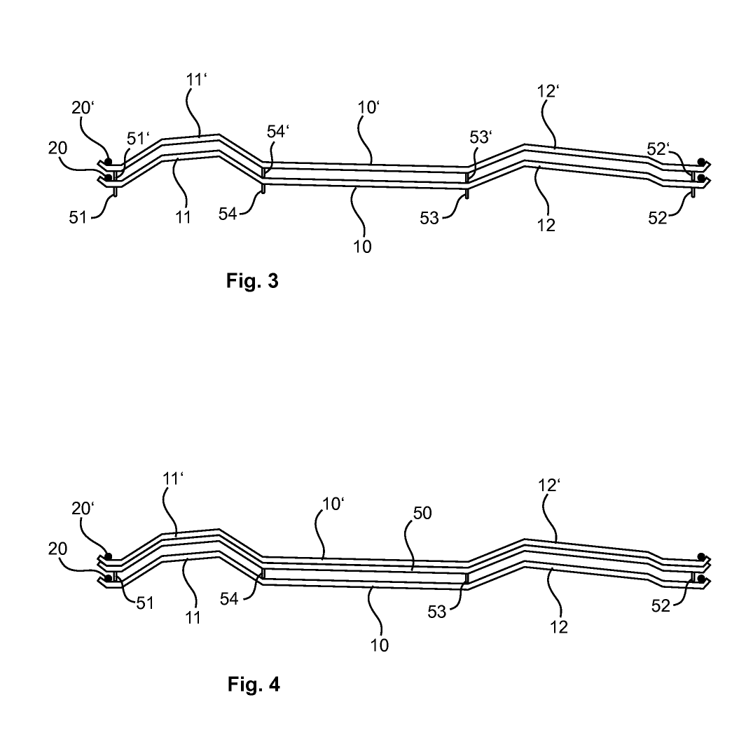

FIG. 3 shows a cross section through two plastic molded parts 10 and 10′, which are stacked one above the other and which are spaced from each other by a first embodiment of the spacing device according to the invention, so that the respective sealing beads 20, 20′ do not touch the plastic molded part that respectively lies above them. In this case, only two stacked plastic molded parts are shown at a time in the Figures; however, the height of the stack is typically increased by further plastic molded parts.

In a first embodiment of the spacing device according to FIG. 3, the latter is a constituent component of the plastic molded part 10, 10′ itself, so that the spacer elements of the spacing device are firmly connected to the plastic molded parts 10, 10′ at least temporarily. To this end, for example, two first spacer elements 51, 51′ and 52, 52′ are provided on each plastic molded part, which are located in the edge region of the plastic molded parts 10, 10′ in such a way that they are located close to the sealing bead 20, 20′. In this case, more than two spacer elements can be provided which are distributed over the circumference of the plastic molded parts 10, 10′.

The height of the first spacer elements 51, 51′, 52, 52′ is selected in such a way that the upper plastic molded part 10′ has no contact with the sealing bead 20 of the plastic molded part 10 that lies underneath it, if it rests on the lower plastic molded part 10 with the spacer elements 51′ and 52′. In that case, the lower plastic molded part 10 rests on the floor with its spacer elements 51 and 52. Preferably, the distance between the two plastic molded parts produced by the spacing device is in that case approximately constant, so that an upper plastic molded part 10′ does not sag, even only in some areas, relative to a plastic molded part 10 lying underneath it. However, it may also be provided that the distance varies over the surface area of a plastic molded part.

The distance between two plastic molded parts substantially depends on the thickness of the sealing bead 20, 20′, but the contour and/or the material of the plastic molded parts can also be decisive factors. If, for example, no spacer elements can be provided at certain locations, because they would otherwise affect the operation of a plastic molded part, there is a risk of an upper spacer element sagging in that region. In order to be able to maintain a minimum distance also in those regions, the height of the insertable spacer elements has to be selected accordingly, with the sagging in some areas being taken into account.

In this case, the first spacer elements 51′ and 52′ of the upper plastic molded part 10′ can lie within or outside the region of the lower plastic molded part 10 delimited by the sealing bead 20, wherein, however, it has proven advantageous to dispose them within, for example, if the region between the sealing bead 20 and the outer edge of the plastic molded part 10 is only very small.

The first spacer elements in the region of the sealing beads can have different shapes, wherein they can be, for example, pins, webs, ribs, profiles, domes, etc. Combinations of these basic shapes are also possible. Furthermore, these spacer elements can also be connected with one another to form a continuous spacer element, so that the upper plastic molded part 10′ rests on the lower plastic molded part 10 with, for example, a peripheral spacer element.

Furthermore, further second spacer elements 53, 53′ and 54, 54′ are provided in the central region of the plastic molded parts 10 and 10′, in order to support the upper plastic molded part 10′ in this region and prevent sagging. Though there is usually no sealing bead to protect in this region, however, the upper plastic molded part 10′ could sag in this central region due to the first spacer elements in the edge region and, for example, become deformed in a disadvantageous manner. These second spacer elements 53, 53′, 54 and 54′ can also be configured as pins, webs, ribs, profiles, domes, etc. or combinations of these basic shapes, and preferably have the same height as the first spacer elements in the region of the adhesive bead. Moreover, more than the two second spacer elements shown in each case can also be provided.

Furthermore, in particular these second spacer elements 53, 53′, 54 and 54′ can be arranged in such a manner that they align the two plastic molded parts 10 and 10′ relative to one another. For this purpose, the spacer elements 53, 53′, 54 and 54′ are positioned in such a way, for example, that, during stacking, they lie exactly in the corners of a depression formed between the two raised portions 11 and 12, whereby the upper plastic molded part 10′ cannot slip to the left or right relative to the lower plastic molded part 10. Slipping in other horizontal directions can also be prevented by further second spacer elements. Depending on the contour of the plastic molded parts and the arrangement of the first spacer elements 51′ and 52′ in the region of the adhesive bead 20, this effect can also be accomplished or at least supported by the first spacer elements.

Individual ones or all of the spacer elements can be firmly connected to the respective plastic molded part at least temporarily. In particular, they can be formed integrally from the material of the plastic molded part and remain on the plastic molded part also in the assembled state. However, spacer elements can also be detachably mounted on the plastic molded parts. This can be done, for example, through simple plug-in connections, so that the spacer elements can be removed when the plastic molded part is installed on a vehicle component. Thus, the spacer elements do not interfere during and after installation. In this case, it is moreover possible that spacer elements can simply be broken off prior to assembly, for which purpose predetermined breaking points, for example, are provided.

In contrast, in a second embodiment of the spacing device according to the invention, the latter is not a constituent component of the plastic molded parts to be stacked, but a separate component which can be inserted between two plastic molded parts, respectively, for stacking. In this embodiment, the spacing device is thus an intermediate layer which is formed and provided with spacer elements in such a way that the desired distance between the plastic molded parts can be produced. In this case, the contour of the intermediate layer substantially follows the contour of the plastic molded parts, and the spacer elements additionally protrude from this contour.

The material thickness of the intermediate layer, too, is therefore preferably approximately constant in all regions, wherein the contour of the intermediate layer with at least one raised portion of depression also comprises no specific portions of thickened material or thinned material, but is produced by appropriate shaping. Also in the case of the intermediate layer, a raised portion on one side at the same time thus means a corresponding depression on the other side of the intermediate layer. The contour of the intermediate layer can thus rest against one of the plastic molded parts, and the protruding spacer elements, together with the material thickness of the intermediate layer, produce the desired distance to the next plastic molded part.

FIG. 4 shows a stack comprising two plastic molded parts 10 and 10′ with such an intermediate layer 50, whose contour substantially follows the contour of the plastic molded parts 10 and 10′ and rests against the upper plastic molded part 10′. Two first spacer elements 51 and 52, with which the upper plastic molded part 10′ rests on the lower plastic molded part 10 in such a way that the upper plastic molded part 10′ does not touch the sealing bead 20 of the lower plastic molded part 10, are provided in the edge region on this intermediate layer 50. Also in this case, another two spacer elements 53 and 54 are provided in a central region, which have a supporting effect in this region, even if there is no sealing bead here that would have to be protected against contact. Both the first spacer elements 51 and 52 in the region of the sealing bead 20 as well as the second spacer elements 53 and 54 in the central region can have the shapes and characteristics previously described with regard to the first embodiment.

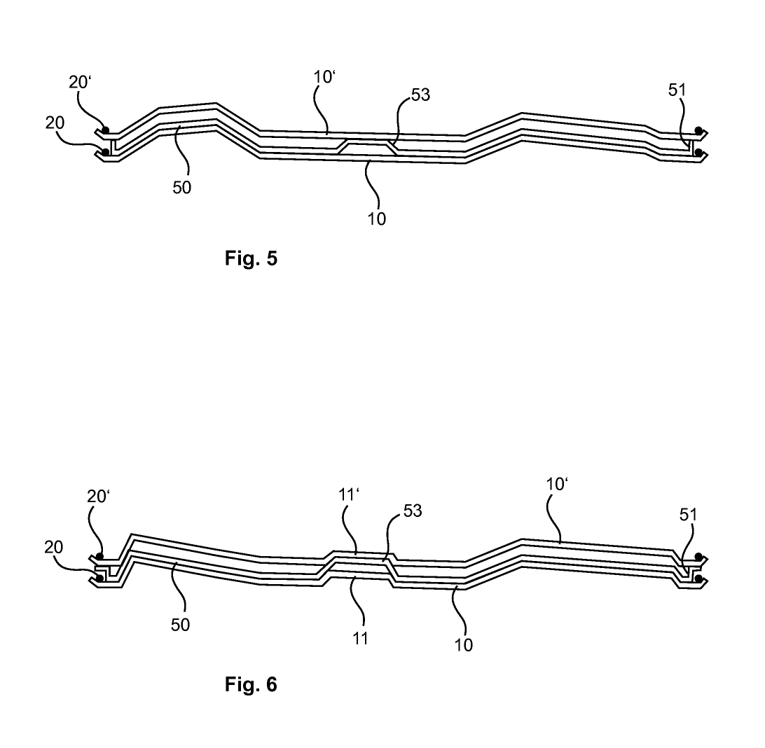

FIG. 5 shows another exemplary embodiment of an intermediate layer 50 between two plastic molded parts 10 and 10′, whose edge region is itself formed into a first spacer element 51. In this case, the contour of the intermediate layer 50 now rests on the lower plastic molded part 10, and the edge region of the intermediate layer 50 is shaped in such a way that the result is an L-shaped profile on whose leg the upper plastic molded part 10′ rests. For this purpose, the circumference of the intermediate layer 50 has to be smaller than the circumference of the plastic molded parts, and, in particular, has to lie within the peripheral sealing bead 20. In this case, the edge of the intermediate layer 50 can be shaped as an L-profile only in some sections, i.e. individual tabs are bent upwards, or this is a peripheral profile, so that the upper plastic molded part 10′ rests on the leg of the L-shaped profile 51 everywhere.

In the central region of the intermediate layer 50, a second spacer element 53 is configured as a supporting member in the exemplary embodiment of FIG. 5, which has the shape of a dome or dome-shaped raised portion protruding from a basic contour of the intermediate layer 50.

Thus, the upper plastic molded part 10′ can rest on this dome 53 and does not sag.

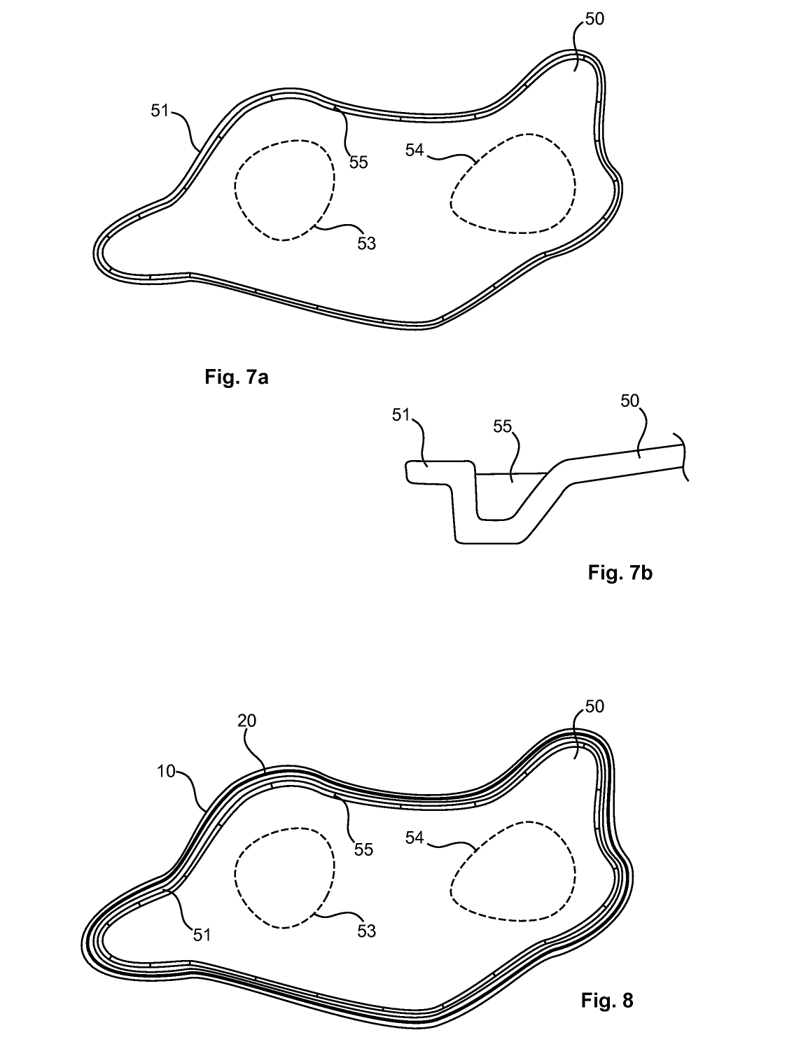

The position and size of this second spacer element in the form of a dome 53 can be selected in such a way that it also supports an alignment of the two plastic molded parts 10 and 10′ relative to one another. By way of example, such an effect is illustrated in the exemplary embodiment of FIG. 6. In this embodiment of the spacing device as an intermediate layer 50, the edge portion of the intermediate layer 50, also due to the contour of the plastic molded parts 10 and 10′, is configured as a U-shaped profile, with the outer leg of this profile being reshaped towards the outside once more, in order to protrude over the sealing bead 20 at least partially. Due to this shape, a kind of roof is formed over the sealing bead 20 which protects the sealing bead 20 in the case of pressure from above on the upper plastic molded part 10′. In order to provide this profile with more stability, the legs of the U-shaped profile can be interconnected by several ribs, as is also apparent from the FIGS. 7a and 7b.

Moreover, the dome 53 is provided as a supporting member in a region in which a raised portion 11 of the lower plastic molded part 10 would engage a corresponding depression 11′ in the upper plastic molded part 10′ in the case of direct stacking, which leads to a straight stack of plastic molded parts. Since this is prevented by the intermediate layer 50, the result could be inclined and, above all, unstable stacks if an upper plastic molded part 10′ rests only loosely on the legs of the outer edge profile and the dome 53. Therefore, the dome 53 is preferably shaped in such a way that its side surface rests against the inner surface of the depression 11′, whereby the upper plastic molded part 10′ cannot slip to the left or the right.

In order to prevent slippage also in other horizontal directions, the side surface of the dome 53 can also rest completely against the inner surface of the raised portion 11′. This can be accomplished in a simple manner, in particular, in the case of circular or oval domes. However, this is also possible in all other shapes, and the first spacer elements in the region of the sealing beads can also be configured and positioned so as to enable this alignment. For example in the exemplary embodiment of FIG. 6, the inner legs of the U-profile 51 in the edge region of the intermediate layer 50 also cause a direct alignment of the intermediate layer 50 relative to the plastic molded parts 10, 10′, and thus indirectly also of the plastic molded parts amongst one another.

Thus, the contour of the intermediate layer 50 substantially follows the contour of the plastic molded parts 10, 10′, but reinforces them or increases their height particularly in the region of depressions and raised portions, in order to again produce an indirect positive fit between the two plastic molded parts via the intermediate layer 50. This dome 53 or other elements are able to prevent slippage in several horizontal directions, so that an intermediate layer can be placed on a lower plastic molded part and automatically slips into the correct position. The same in that case applies to the next plastic molded part placed on this intermediate layer.

FIG. 7a shows a top view of an exemplary embodiment of an intermediate layer with a peripheral edge in the form of a U-profile. The legs of the profile are in this case interconnected by means of several ribs 55, so that the legs of the profile are not pushed apart in the case of pressure from above. This is also illustrated in an enlarged fashion in the view of FIG. 7b for a rib 55. Several second spacer elements 53 and 54 in the form of domes represented in dashed lines can also be seen in FIG. 7a.

FIG. 8 shows a top view of a lower plastic molded part 10 with a peripheral adhesive bead 20 on which an intermediate layer 50 was placed. In this case, the circumference of the intermediate layer 50 is smaller than the circumference of the plastic molded part 10, and the intermediate layer 50 in particular lies within a region delimited by the peripheral adhesive bead 20, so that the intermediate layer 50 does not protrude over the adhesive bead 20.

In order to discern the intermediate layer in a stack from the plastic molded parts, they may be of a different color. Moreover, handle members may be formed on the intermediate layer in order to securely place an intermediate layer on a plastic molded part or remove it without touching the adhesive bead of the plastic molded part in the process. Furthermore, it may be provided that means for safely storing and/or transporting the stack of plastic molded parts are formed on the intermediate layer 50. These may be, for instance, eyelets or cut-outs in the edge region of the intermediate layer through which fastening straps can be pulled with which the plastic molded part are tied together. For this purpose, it would be advantageous if the intermediate layer protrudes out over the plastic molded parts.

1. A spacing device for stacking at least two identically formed, flat plastic molded parts having a contour formed by at least one raised portion, which forms a corresponding depression on the other side of a respective plastic molded part, with at least one peripheral adhesive bead, with which the plastic molded parts, upon being attached to a vehicle component, can each be sealed against the latter, being applied on the edge of each plastic molded part, wherein the spacing device comprises at least two spacer elements and is configured and positionable between two plastic molded parts in such a way that the spacer elements are in contact with both plastic molded parts, and the height, shape and/or arrangement of the at least two spacer elements are selected in such a way that the two plastic molded parts do not touch each other during stacking, and the adhesive bead of a lower plastic molded part does not touch the plastic molded part (10′) stacked above it, wherein at least one first spacer element is located in an outer region of the plastic molded parts close to the adhesive bead, whereas at least one second spacer element is located in a central region of the plastic molded parts.

2. The spacing device according to claim 1, wherein the spacer elements are configured as a dome, web, pin, rib, profile or combinations thereof.

3. The spacing device according to claim 1, wherein the distance between the two plastic molded parts produced by the spacing device is approximately constant over the contour of the plastic molded parts.

4. The spacing device according to claim 1, wherein the at least one first spacer element, when the at least two plastic molded parts are being stacked, lies inside or outside the region of a lower plastic molded part formed by the peripheral adhesive bead.

5. The spacing device according to claim 1, wherein at least one spacer element is configured and arranged in such a way that it aligns the two plastic molded parts relative to one another during stacking.

6. The spacing device according to claim 1, wherein the spacing device comprising the at least two spacer elements is at least temporarily a firmly attached component of each plastic molded part.

7. The spacing device according to claim 1, wherein the spacing device comprising the at least two spacer elements is a separate component which can be inserted as an intermediate layer between two plastic molded parts to be stacked.

8. The spacing device according to claim 7, wherein the intermediate layer has a contour in which a raised portion on one side of the intermediate layer forms a corresponding depression on the other side of the intermediate layer.

9. The spacing device according to claim 7, wherein the intermediate layer has a contour corresponding to the contour of the plastic molded parts to be stacked, wherein the at least two spacer elements protrude from this contour, and the distance between the two plastic molded parts created by introducing the spacing device corresponds at least to the sum of the material thickness of the intermediate layer and the height of the spacer elements protruding from the contour.

10. The spacing device according to claim 7, wherein the circumference of the intermediate layer is smaller than the circumference of the plastic molded parts, and an intermediate layer, if introduced centrally between two plastic molded parts, does not protrude outwards over an adhesive bead.

11. The spacing device according to claim 7, wherein the at least one first spacer element is located within the region of a plastic molded part formed by the peripheral adhesive bead in such a way that the intermediate layer protrudes outwards over an adhesive bead without touching it.

12. The spacing device according to claim 7,
wherein several first spacer elements in the form of webs and/or pins are formed on the outer edge of the intermediate layer.

13. The spacing device according to claim 7, wherein a first spacer element is formed by the outer edge of the intermediate layer being configured as an L-shaped or U-shaped profile.

14. The spacing device according to claim 7, wherein at least one second spacer element in the form of a dome is formed in a central region of the intermediate layer.

15. The spacing device according to claim 7, wherein at least one spacer element is configured and disposed in such a way that, when the spacing device is introduced as an intermediate layer between two plastic molded parts to be stacked, at least one side surface of the spacer element rests against an inner surface of a depression within the contour of a plastic molded part, whereby the two plastic molded parts are indirectly aligned relative to one another.
